(19) United States
(12) Patent Application Publication
(10) Pub. No.: US 2023/0211410 A1
(43) Pub. Date: Jul. 6, 2023

(54) SILVER POWDER FOR CONDUCTIVE PASTE HAVING IMPROVED VISCOSITY STABILITY, AND PREPARATION METHOD THEREFOR

(71) Applicant: LS-NIKKO COPPER INC., Ulsan (KR)

(72) Inventors: Woo Min JIN, Ulsan (KR); Chang Gun LEE, Ulsan (KR)

(21) Appl. No.: 17/914,571

(22) PCT Filed: Dec. 29, 2020
(86) PCT No.: PCT/KR2020/019268

§ 371 Date: Sep. 26, 2022

(30) Foreign Application Priority Data
Mar. 25, 2020 (KR) 10-2020-0036248

(51) Int. Cl. B22F 1/102; B22F 9/24

(52) U.S. Cl. CPC B22F 1/102; B22F 9/24; B22F 2301/255; B22F 2303/01; H01B 1/22

(57) ABSTRACT

The present disclosure relates to a silver powder preparation method comprising: a silver powder preparation step of preparing a silver salt, which comprises silver ions, and then reducing the silver ion so as to precipitate silver particles; a silver powder recovery step of separating silver particles from an aqueous solution or a slurry, which comprises the precipitated silver particles, and then washing and drying same to recover silver powder; and a silver powder coating step of injecting a pH adjuster into the recovered silver powder to adjust the pH, and then injecting a coating agent to coat after the pH adjustment. The pH adjuster is used in the silver powder coating step to adjust the pH, and thus, when silver power is used in a conductive paste, as the rate of change in viscosity over time is low, a conductive paste having excellent viscosity stability can be provided.

### TECHNICAL FIELD

The present disclosure relates to a silver powder for a conductive paste and a method for preparing the same. The present disclosure relates to a silver powder for improving the viscosity stability of a conductive paste for forming an electrode in an electronic component such as an electrode for a solar cell, an internal electrode of a multilayer capacitor, and a conductor pattern of a circuit board, and a method for preparing the same.

### BACKGROUND ART

The conductive metal paste is a paste that has applicability to form a coating film and conducts electricity to a dried coating film. The conductive metal paste has a fluid composition in which a conductive filler (metal filler) is dispersed in a vehicle composed of a resin binder and solvent and is widely used in the formation of electric circuits and the formation of external electrodes of ceramic capacitors and the like.

In particular, silver paste is the most chemically stable and excellent in conductivity among composite conductive pastes and thus has a wide application range in various fields such as conductive adhesion and coating and the formation of fine circuits. In electronic components, such as printed circuit boards (PCBs), where reliability is particularly important, silver paste is used in various ways for silver through holes (STH), adhesives, or coating agents.

On the other hand, a solar cell is a device that obtains electric power using the photovoltaic effect in which electricity is generated when light is incident on a semiconductor substrate and generally has a structure in which a cathode electrode is formed on the front surface (a surface irradiated with sunlight) of a semiconductor substrate made of p-type silicon, and an anode is formed on a rear surface. The solar cell electrode is formed by screen-printing and sintering a conductive paste composition for forming an electrode on a substrate, and the conductive paste composition for forming an electrode is made of a conductive organic medium including electrically conductive powder, glass frit, organic solvent, and a cellulose resin binder.

When the viscosity of the conductive paste changes over time, printability changes, and thus an appropriate film thickness or shape is not obtained during printing, and thus an electrode having stable quality may not be prepared.

(Patent Literature 1), Korean Patent Laid-Open Publication No. 10-2016-0016612 (published date 2016. 02. 15)

(Patent Literature 2), Korean Patent No. 10-1775760 (published date: 2017. 08. 31)

### DISCLOSURE

### Technical Problem

An objective of the present disclosure is to provide a silver powder for improving the viscosity stability of a conductive paste and a method for preparing the same in order to solve the above problems.

However, the objectives of the present disclosure are not limited to the above-mentioned objectives, and other objectives not mentioned will be clearly understood by those skilled in the art from the following description.

### Technical Solution

The present disclosure provides a method of preparing silver powder, the method including: preparing silver powder with precipitating silver particles by reducing silver ions after preparing a silver salt containing silver ions; recovering silver powder by separating silver particles from the aqueous solution or slurry containing the precipitated silver particles, washing, and drying; and coating silver powder by coating a pH-adjusted coating agent that a pH control agent is added to the recovered silver powder to adjust the pH, and then a coating agent is adjusted the pH.

In addition, the coating of silver powder may include: adjusting the pH of the silver powder solution by adding the recovered silver powder to pure water and stirring, then adding a pH adjusting agent and stirring; and a coating by adding a coating agent into the pH-adjusted silver powder solution.

In addition, the pH adjusting is adjusting the pH to 8 to 12 by adding 200 to 400 parts by weight of pure water based on 100 parts by weight of the recovered silver powder and stirring for 5 to 15 minutes, then adding the pH adjusting agent and stirring for 5 to 15 minutes.

In addition, the pH adjusting includes the pH adjusting agent, which is at least one selected from the group consisting of 2-amino-2-methyl-1-propanol, triethanolamine, and ammonium hydroxide.

In addition, the coating agent includes a fatty acid or a salt thereof, and the fatty acid includes at least one selected from the group consisting of stearic acid, oleic acid, myristic acid, palmitic acid, linolic acid, lauric acid, and linoleic acid.

In addition, the present disclosure provides silver powder prepared according to the above method, in which the silver powder has a parameter value expressed as a chemical binding amount (%) of a coating agent with respect to a specific surface area (m²/g) of 0.3 or less.

In addition, the present disclosure provides a conductive paste including: metal powder including a silver powder prepared according to the above method; and a glass vehicle including a solvent and an organic binder.

In addition, the present disclosure provides a conductive paste for a solar cell electrode including: metal powder including silver powder prepared according to the above method; glass frit; and an organic vehicle including solvent and an organic binder.

### Advantageous Effects

The present disclosure relates to a silver powder for a conductive paste for forming a front electrode of a solar cell in particular, in which since the pH of the silver powder is adjusted by using a pH adjusting agent during the silver powder coating process when used in the conductive paste, a conductive paste having excellent viscosity stability may be provided due to a small viscosity increase and decrease rate over time.

In addition, when an electrode is manufactured using the conductive paste, including the silver powder, a change in printability over time is minimized to obtain an appropriate film thickness or shape during printing, thereby providing an effect of manufacturing an electrode with stable quality.

### DESCRIPTION OF DRAWINGS

FIG. 1 shows a method for analyzing the organic material content of the silver powder.

### BEST MODE

Before describing the present disclosure in detail below, it should be understood that the terms used in the present specification are for describing a specific embodiment and are not intended to limit the scope of the present disclosure, limited only by the scope of the appended patent claim. All technical and scientific terms used herein have the same meaning as commonly understood by those of ordinary skilled in the art, unless otherwise stated.

Throughout the specification and claims, unless otherwise stated, the term “comprise”, “comprises”, and “comprising” means including the mentioned objective, step, or group of objectives and is not used to exclude any other objective, step, or group of objects or groups of objectives.

On the other hand, various embodiments of the present disclosure may be combined with any other embodiments unless clearly indicated to the contrary. Any feature indicated as particularly preferred or advantageous may be combined with any other feature and features indicated as preferred or advantageous. Hereinafter, embodiments of the present disclosure and effects thereof will be described with reference to the accompanying drawings.

The present disclosure improves the viscosity stability of a conductive paste, including silver powder, obtained by adjusting the pH using a pH adjusting agent in a coating process of the generated silver powder. Therefore, when the electrode is manufactured using a conductive paste, including the silver powder, the change in printability over time can be minimized to obtain an appropriate film thickness or shape during printing, thereby manufacturing an electrode with stable quality.

The method for preparing a silver powder according to an embodiment of the present disclosure includes a silver powder preparation step S1, a silver powder recovery step S2, and a silver powder coating step S3. Hereinafter, each step will be described in detail.

The silver powder preparation step S1, according to an embodiment of the present disclosure, includes a silver salt preparation step S11 and a silver salt reduction step S12.

The silver salt preparation step S11, according to an embodiment of the present disclosure, is preparing a silver salt solution containing silver ions (Ag) by acid-treating silver (Ag) in the form of ingots, ribs, and granules. Through the present step, silver powder may be prepared by directly preparing a silver salt solution, but a subsequent step may be performed using a commercially purchased silver nitrate (AgNO₃), a silver salt complex, or a silver intermediate solution.

The silver salt reduction step S12, according to an embodiment of the present disclosure, is reducing silver ions by adding a reducing agent and ammonia to a silver salt solution to precipitate silver particles. The step includes a reaction solution preparation step S121 of preparing a first reaction solution containing silver ions, ammonia, and nitric acid and a second reaction solution containing a reducing agent, and a precipitation step S122 of obtaining silver powder by reacting the first reaction solution and the second reaction solution.

In the reaction solution preparation step S121 according to an embodiment of the present disclosure, ammonia and nitric acid are added to a silver salt solution containing silver ions and dissolved by stirring to prepare a first reaction solution.

The silver ion is not limited as long as a material is included in the form of a silver cation. For example, the silver ion may be silver nitrate (AgNO₃), a silver salt complex, or a silver intermediate. Preferably, silver nitrate (AgNO₃) is used. Hereinafter, the use of silver nitrate (AgNO₃) containing silver ions at a concentration of 500 g/L will be described as an example.

Ammonia (NH₃) may be used in the form of an aqueous solution, and when a 25% aqueous ammonia solution is used, the ammonia solution is added in an amount of 100 to 150 parts by weight based on 100 parts by weight of silver nitrate (AgNO₃). When the aqueous ammonia solution is added in an amount of less than 100 parts by weight, the reaction pH is low so that all silver ions are not reduced, or there is a problem in forming a uniform particle distribution. When the aqueous ammonia solution is added in an amount of more than 150 parts by weight, there is a problem that the organic material content in the prepared silver powder is excessively high. Preferably, 120 to 140 parts by weight of a 25% aqueous ammonia solution are added based on 100 parts by weight of silver nitrate (AgNO₃). The ammonia includes its derivatives.

Nitric acid (HNO₃) may be used in the form of an aqueous solution, and when a 60% aqueous nitric acid solution is used, the aqueous nitric acid is added in an amount of 40 to 120 parts by weight based on 100 parts by weight of silver nitrate (AgNO₃). When nitric acid (HNO₃) is added in an amount of less than 40 parts by weight, it is difficult to control the size of the silver powder, and when nitric acid (HNO₃) is added in an amount of more than 120 parts by weight, there is a problem in that the organic material content is greatly increased. Preferably, 80 to 100 parts by weight of a 60% aqueous nitric acid solution are added based on 100 parts by weight of silver nitrate (AgNO₃). The nitric acid includes its derivatives.

The first reaction solution containing silver ions, ammonia, and nitric acid may be prepared in an aqueous solution state by adding silver ions, aqueous ammonia, and nitric acid aqueous solution to a solvent such as water and stirring to dissolve them, and also may be prepared in the form of a slurry.

The reaction solution preparation step S121, according to an embodiment of the present disclosure, also prepares a second reaction solution, including a reducing agent.

The reducing agent may be at least one selected from the group consisting of ascorbic acid, alkanolamine, hydroquinone, hydrazine, and formalin, and hydroquinone may be preferably selected from among them. The content of the reducing agent is preferably included in an amount of 10 to 20 parts by weight based on 100 parts by weight of silver nitrate (AgNO₃) included in the first reaction solution. When the content of the reducing agent is used in an amount of less than 10 parts by weight, all silver ions may not be reduced, and when the content of the reducing agent is used in an amount of more than 20 parts by weight, there is a problem in that the organic material content increases. Preferably, the second reaction solution is prepared by using 14 to 16 parts by weight of a reducing agent based on 100 parts by weight of silver nitrate.

The second reaction solution, including the reducing agent, may be prepared in an aqueous solution state by adding a reducing agent to a solvent such as water and stirring to dissolve the reducing agent.

The precipitation step S122, according to an embodiment of the present disclosure, is a step of obtaining silver powder by reacting the first reaction solution and the second reaction solution. In a state in which the first reaction solution prepared in step S121 is stirred, the second reaction solution may be slowly added dropwise or batch added to react. Preferably, it is preferable to grow the particles in the mixed solution by stirring for 5 to 10 minutes after the batch addition so that the reduction reaction is completed in a short time to prevent aggregation of the particles and increase the dispersibility.

On the other hand, in an embodiment of the present disclosure, the method may further include adding 80 to 160 parts by weight of an alkali washing solution such as caustic soda based on 100 parts by weight of silver nitrate (AgNO₃) in order to remove organic material generated after the reaction and stirring the same for 5 to 20 minutes.

The silver powder recovery step S2, according to an embodiment of the present disclosure, is a step of separating, washing, and drying the silver powder dispersed in the aqueous solution or the slurry by filtration after completing the silver particle precipitation reaction through the silver powder preparation step S1.

The silver powder preparation method, according to the present disclosure, is a method that is suitably applied to a mass production process that reacts at least about 100 kg in one reaction. In the case of the existing centrifugation method, separation is not properly performed, and in order to complete separation, the size of the equipment increases or the separation time increases, so economic feasibility is poor. Since the separated silver powder has a high moisture content, it is difficult to recover the separated silver powder again, and thus the silver powder prepared in a large amount is recovered using a filter press in the present disclosure.

In the silver powder recovery step S2, according to an embodiment of the present disclosure, the mixed solution in a slurry state, including the silver particles precipitated in the silver powder preparation step S1 is introduced into the filter press chamber, and the filtrate is separated through squeezing to obtain a silver powder in a cake state (squeezing step S21). Thereafter, the silver powder in the cake state is washed using a washing solution such as pure water (washing step S22). The silver powder is recovered by introducing compressed air thereto and drying the silver powder while controlling the moisture content (drying step S23).

The squeezing step S21 is a step of introducing a slurry-state mixed solution containing the prepared silver powder into a filter press chamber and separating a filtrate through squeezing to obtain a cake-state silver powder. More preferably, the injected slurry is formed in a cake state by removing the filtration solution using the filter cloth of the chamber.

The washing step S22 is a step of washing the filtered silver powder in a cake state using a washing solution such as pure water. It is more preferably to wash the waste liquid discharged after washing until the conductivity of the waste liquid discharged is 50 μScm or less.

The squeezing step S21 and the washing step S22 may be repeatedly performed.

The drying step S23 is a step of drying while controlling the moisture content by introducing compressed air into the washed silver powder, and more preferably, it is recommended to recover the silver powder by drying the washed silver powder by introducing compressed air for 40 to 80 minutes until the moisture content reaches to a range of 10% to 20%.

In the silver powder coating step S3, according to the present disclosure, a pH adjusting agent is added to the recovered silver powder to adjust the pH (pH control step S31), a coating agent is added to adjust the pH, and then coating (coating step S32), thereby improving viscosity stability of the prepared silver powder.

The pH adjusting step S31 is a step of adjusting the pH for optimal coating in the coating step S32 by adding a pH adjusting agent to the recovered silver powder. The recovered silver powder is added to pure water and stirred, and then a pH adjusting agent is added and stirred.

The pH adjusting agent may be at least one species selected from the group consisting of 2-amino-2-methylpropanol, triethanolamine, and ammonium hydroxide. It is preferable in terms of the viscosity stability of the conductive paste to be described later to adjust the pH using ammonium hydroxide.

The pH adjusting step S31 is performed by adding 200 to 400 parts by weight of pure water based on 100 parts by weight of the recovered silver powder and stirring for 5 to 15 minutes, then adding the pH adjusting agent and stirring for 5 to 15 minutes to adjust the pH in a range of 8 to 12. When the pH is adjusted to prepare a basic solution as described above, the coating agent may be well dissociated and chemically well bonded to the powder, and the prepared powder has a well-coated surface to improve dispersion stability. In addition, there is only an amount capable of binding depending on the specific surface area of the powder to be chemically bonded. On the other hand, when the coating agent is prepared as an acidic solution, since the coating agent is adsorbed to the surface of the powder without dissociation and may be removed depending on a solvent or other conditions, the surface of the silver powder is exposed, thereby degrading powder stability. Preferably, it is good to adjust the pH to 10 or more by using the above pH adjusting agent.

The coating step S32 is a step of coating by adding a coating agent to the pH-adjusted silver powder solution, and the coating agent uses a coating agent containing fatty acid or a salt thereof.

The fatty acid is not particularly limited but is preferably at least one selected from the group consisting of stearic acid, oleic acid, myristic acid, palmitic acid, linolic acid, lauric acid, and linoleic acid.

The coating agent may be added as a coating solution with a concentration of 10% using an ethanol solution as a solvent, and 2 to 8 parts by weight of the coating agent is added based on 250 parts by weight of the reduced silver powder. When the coating agent is added in an amount of less than 2 parts by weight, there is a problem in that suppressing aggregation of the silver powder, or the adsorption property of the coating agent is reduced. When the coating agent is added in an amount of more than 8 parts by weight, there is a problem in that the amount of coating agent adsorbed onto the silver powder is too large, and thus conductivity of a wiring layer or an electrode formed by using a conductive paste including the silver powder may not be sufficiently obtained. Preferably, the coating agent is added in an amount in a range of 5 to 8 parts by weight based on 250 parts by weight of the reduced silver powder.

In the coating step S32, the coating agent is added to the reduced silver powder solution and stirred for 10 to 30 minutes to coat the coating agent. In the coating step, according to the present disclosure, since the coating is performed on the silver powder obtained by reducing silver oxide, the amount of the coating agent adsorbed to the silver powder increases as compared to the case where the reduction step is not performed.

After the pH adjusting step S31, even if the washing step is further included before the coating step S32, the viscosity stability of the conductive paste, including the obtained silver powder is improved, but the viscosity stability of the conductive paste, including silver powder obtained by performing the coating step S32 without washing after the pH adjusting step S31 provides a more excellent effect.

Thereafter, the silver powder is recovered by centrifugation and washed to obtain the final silver powder. The silver powder prepared by the method according to the present disclosure has a low parameter value of 0.3 or less, expressed as the amount of chemical bonding (%) of the coating agent with respect to the specific surface area (m²/g), as shown in Experimental Examples to be described later.

In the present disclosure, the amount of chemical bonding is identified by checking TG/DTA under the condition of increasing the temperature by 10° C. per minute. When the coating amount is large, the amount of physical adsorption and the amount of chemical bonding overlap, and thus the amount of physical adsorption is included in the amount of chemical bonding. Accordingly, since the amount of chemical bonding is high even under the condition of low pH, the parameter value expressed as the amount of chemical bonding (%) of the coating agent with respect to the specific surface area of the powder exceeds 0.3, and in this case, the dispersion stability of the paste and change over time is reduced. The physical adsorption amount is a value that may continue to increase regardless of a specific surface area, and when a parameter value expressed as the amount of chemical bonding (%) of the coating agent with respect to the specific surface area of the powder exceeds 0.3, the physical adsorption amount of the coating agent may increase, thereby degrading dispersion stability of a paste.

The present disclosure also provides a conductive paste, including silver powder prepared, according to an embodiment of the present disclosure. The conductive paste includes a metal powder and an organic vehicle.

As the metal powder, a silver powder prepared, according to an embodiment of the present disclosure, is used. The content of the metal powder is preferably 85% to 95% by weight based on the total weight of the conductive paste composition in consideration of the thickness of the electrode formed during printing and the wire resistance of the electrode.

The organic vehicle is a mixture of 5% to 15% by weight of an organic binder in a solvent and is preferably included in an amount of 5% to 15% by weight based on the total weight of the conductive paste composition.

The organic binder is a cellulose ester-based compound and may be, for example, cellulose acetate, cellulose acetate butylate, or the like, and examples of the cellulose ether-based compound may include ethyl cellulose, methyl cellulose, hydroxypropyl cellulose, hydroxyethyl cellulose, hydroxypropyl methyl cellulose, hydroxyethyl methyl cellulose, and examples of the acrylic compound may include polyacrylamide, polymethacrylate, polymethyl methacrylate, polyethyl methacrylate, and examples of the vinyl-based compound may include polyvinyl butyral, polyvinyl acetate, and polyvinyl alcohol. At least one organic binder may be selected and used.

The solvent used for dilution of the composition may be at least one aromatic compound selected from the group consisting of alcohols such as methanol, ethanol, n-propanol, benzyl alcohol, and terpineol; ketones such as acetone, methyl ethyl ketone, cyclohexanone, isophorone, and acetylacetone; amides such as N,N-dimethylformamide and N,N-dimethylacetamide; ethers such as tetrahydrofuran, dioxane, methylcellosolve, diglyme, and butylcarbitol; esters such as methyl acetate, ethyl acetate, diethyl carbonate, 1-isopropyl-2,2-dimethyltrimethylenediisobutyrate (TXIB), carbitol acetate, and butylcarbitol acetate; sulfoxides and sulfones such as dimethyl sulfoxide and sulfolane; aliphatic halogenated hydrocarbons such as methylene chloride, chloroform, carbon tetrachloride, and 1,1,2-trichloroethane; and aromatics such as benzene, toluene, o-xylene, p-xylene, m-xylene, monochlorobenzene, and dichlorobenzene.

In addition, when the conductive paste is used for forming a solar cell electrode, the conductive paste, according to the present disclosure, includes metal powder, glass frit, and an organic vehicle.

As the metal powder, a silver powder prepared according to an embodiment of the present disclosure is used. The content of the metal powder is preferably 85% to 95% by weight based on the total weight of the conductive paste composition in consideration of the thickness of the electrode formed during printing and the wire resistance of the electrode.

The composition, particle size, and shape of the glass frit are not particularly limited. Lead-containing glass frit, as well as lead-free glass frit, can be used. Preferably, as a component and content of the glass frit, 5 to 29 mol % of PbO, 20 to 34 mol % of TeO₂, 3 to 20 mol % of Bi₂O₃, 20 mol % or less of SiO₂, and 10 mol % or less of B₂O₃, and 10 to 20 mol % of an alkali metal (Li, Na, K, etc.) and an alkaline metal (Ca, etc.) based on oxide conversion may be contained. An increase in the electrode line width can be prevented, contact resistance can be improved in high surface resistance, and short current characteristics can be improved by the organic content combination of each component.

The average particle diameter of the glass frit is not limited but may have a particle diameter within the range of 0.5 to 10 μm and may be used by mixing various types of particles having different average particle diameters. Preferably, at least one glass frit having an average particle diameter (D50) of 2 μm or more and 10 μm or less is used. Through this, the reactivity during sintering is enhanced, damage to the n-layer is minimized, particularly at a high temperature, the adhesion strength can be improved, and open-circuit voltage (Voc) can be improved. In addition, it is possible to reduce an increase in the line width of the electrode during sintering.

In addition, the content of the glass frit is preferably 1% to 5% by weight based on the total weight of the conductive paste composition. When the content of the glass frit is less than 1% by weight, there is a risk that incomplete sintering is occurred to increase the electrical resistivity, and when the content of the glass frit is more than 5% by weight, there is a concern that the electrical specific resistance may also increase as there are too many glass components in the sintered body of the silver powder.

The organic vehicle is not limited but may include an organic binder and a solvent. Sometimes the solvent can be omitted. The organic vehicle is not limited but is preferably 1% to 10% by weight based on the total weight of the conductive paste composition.

The organic vehicle is required to maintain a uniformly mixed state of metal powder and glass frit. For example, when a conductive paste is coated to a substrate by screen printing, it is required to homogenize the conductive paste to suppress blurring and smudging of the printing pattern and to allow the conductive paste from the screen plate to pass well and separate the plate.

The organic binder included in the organic vehicle is not limited, but examples of the cellulose ester-based compound may include cellulose acetate and cellulose acetate butyrate, and examples of the cellulose ether-based compound may include ethyl cellulose, methyl cellulose, hydroxypropyl cellulose, hydroxyethyl cellulose, hydroxypropylmethyl cellulose, and hydroxyethylmethyl cellulose, and examples of the acrylic compound may include polyacrylamide, polymethacrylate, polymethyl methacrylate, and polyethyl methacrylate, and examples of the vinyl-based compound may include polyvinyl butyral, polyvinyl acetate, and polyvinyl alcohol. At least one organic binder may be selected and used.

The solvent used for dilution of the composition may be at least one compound selected from the group consisting of alpha-terpineol, texanol, dioctyl phthalate, dibutyl phthalate, cyclohexane, hexane, toluene, benzyl alcohol, dioxane, diethyleneglycol, ethyleneglycol monobutylether, ethyleneglycol monobutylether acetate, diethyleneglycol monobutyl ether, diethyleneglycol monobutyl ether acetate, and the like.

The conductive paste composition according to the present disclosure may further include, if necessary, commonly known additives, for example, a dispersant, a plasticizer, a viscosity adjusting agent, a surfactant, an oxidizing agent, a metal oxide, a metal organic compound, and the like.

It will be confirmed in Examples and Experimental Examples to be described later that the conductive paste, according to the present disclosure, has excellent viscosity stability with a viscosity increase/decrease rate of ±12% or less after 24 hours and a viscosity increase/decrease rate of ±17% or less after 48 hours.

The present disclosure also provides a method for forming an electrode of a solar cell, in which the conductive paste is coated on a substrate, dried, and sintered, and a solar cell electrode is manufactured by the method. Except for using the conductive paste containing the silver powder of the above characteristics in the method for forming the solar cell electrode of the present disclosure, the substrate, printing, drying, and sintering can be performed using methods commonly used for manufacturing solar cells. For example, the substrate may be a silicon wafer.

### Examples and Comparative Examples—Preparation of Silver Powder

### (1) Example 1

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. In order to remove the organic material produced after the reaction, 0.8 kg of caustic soda was added and stirred for 10 minutes.

Using a filter press to recover the silver powder in the mixed solution and additionally flow pure water so that the conductivity of the washed waste solution is 50 μScm or less. Then, compressed air was flowed for 1 hour and dried until the contained moisture reached about 10% to 20% to recover the silver powder.

Put 250 g of the recovered silver powder into 750 g of pure water, and after stirring for 10 minutes with a homo-mixer, 4.7 g of 2-amino-2-methyl-1-propanol (90%) was added and stirred for 10 minutes. Thereafter, 7.5 g of a 10% ethanol solution of stearic acid was added. and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

### (2) Example 2

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. In order to remove the organic material produced after the reaction, 0.8 kg of caustic soda was added and stirred for 10 minutes.

Using a filter press (filter press) to recover the silver powder in the mixed solution and additionally flow pure water so that the conductivity of the waste solution is 50 μScm or less. Then, compressed air was flowed for 1 hour and dried until the contained moisture reached about 10% to 20% to recover the silver powder.

Put 250 g of the recovered silver powder into 750 g of pure water, and after stirring for 10 minutes with a homo-mixer, 50 g of triethanolamine (98%) was added and stirred for 10 minutes. Thereafter, 7.5 g of a 10% ethanol solution of stearic acid was added, and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

### (3) Example 3

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. In order to remove the organic material produced after the reaction, 0.8 kg of caustic soda was added and stirred for 10 minutes.

Using a filter press (filter press) to recover the silver powder in the mixed solution and additionally flow pure water so that the conductivity of the waste solution is 50 μScm or less. Then, compressed air was flowed for 1 hour and dried until the contained moisture reached about 10% to 20% to recover the silver powder.

Put 250 g of the recovered silver powder into 750 g of pure water, and after stirring for 10 minutes with a homo-mixer, 50 g of triethanloamine (98%) was added and stirred for 10 minutes. Thereafter, 7.5 g of a 10% ethanol solution of stearic acid was added, and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

### (4) Example 4

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. In order to remove the organic material produced after the reaction, 0.8 kg of caustic soda was added and stirred for 10 minutes.

Using a filter press (filter press) to recover the silver powder in the mixed solution and additionally flow pure water so that the conductivity of the waste solution is 50 μScm or less. Then, compressed air was flowed for 1 hour and dried until the contained moisture reached about 10% to 20% to recover the silver powder.

Put 250 g of the recovered silver powder into 750 g of pure water, and after stirring for 10 minutes with a homo-mixer, 0.23 g of ammonium hydroxide (25%) was added and stirred for 10 minutes. Thereafter, 7.5 g of a 10% ethanol solution of stearic acid was added, and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

### (5) Example 5

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. In order to remove the organic material produced after the reaction, 0.8 kg of caustic soda was added and stirred for 10 minutes.

Using a filter press (filter press) to recover the silver powder in the mixed solution and additionally flow pure water so that the conductivity of the waste solution is 50 μScm or less. Then, compressed air was flowed for 1 hour and dried until the contained moisture reached about 10% to 20% to recover the silver powder.

Put 250 g of the recovered silver powder into 750 g of pure water, and after stirring for 10 minutes with a homo-mixer, 0.46 g of ammonium hydroxide (25%) was added and stirred for 10 minutes. Thereafter, 7.5 g of a 10% ethanol solution of stearic acid was added, and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

### (6) Comparative Example 1

The first aqueous solution was prepared by adding 1.28 kg of silver nitric acid with a concentration of 500 g/L of silver, 1.57 kg of ammonia (concentration 25%), and 1.26 kg of nitric acid (concentration 60%) to 6.6 kg of pure water at room temperature. On the other hand, 0.2 kg of hydroquinone was added to 10 kg of pure water at room temperature and dissolved by stirring to prepare a second aqueous solution. The first aqueous solution was stirred, and the second aqueous solution was added to the first aqueous solution at once, and the mixture was further stirred for 5 minutes after the addition was completed to grow particles in the mixed solution. Thereafter, stirring was stopped, particles in the mixed solution were precipitated, the supernatant of the mixed solution was discarded, the mixed solution was filtered using a centrifuge, the filtrate was washed with pure water, and dried to recover silver powder.

Put 250 g of the recovered silver powder into 750 g of pure water, stirred with a homo-mixer for 10 minutes, and then 7.5 g of a 10% ethanol solution of stearic acid was added, and coating was performed for 20 minutes. Thereafter, the coated silver powder was recovered by centrifugation and washed so that the conductivity of the washed waste solution was 50 μScm or less to obtain silver powder.

After drying the obtained silver powder at 80° C. for 12 hours, the dried silver powder was pulverized in a food mixer and pulverized in a jet mill to obtain a final silver powder.

TABLE 1

Coating process

| | pH adjusting agent | Usage (g) | pH |
|---|---|---|---|
| Example 1 | 2-Amino-2-Methyl-1- | 4.7 | 11.4 |
| | propanol | | |
| Example 2 | Triethanolamine | 50 | 10.7 |
| Example 3 | Ammonium Hydroxide | 0.23 | 8.5 |
| Example 4 | Ammonium Hydroxide | 0.46 | 10.1 |
| Example 5 | Ammonium Hydroxide | 4.6 | 11.2 |
| Comparative | — | — | 6.0 |
| Example 1 | | | |

### Experimental Example (1)—Analysis of Specific Surface Area, Particle Size Distribution, and Organic Material Content

The specific surface area by nitrogen adsorption using a specific surface area measuring device (BELSORP mini-II, BEL Japan) after removing moisture from the silver powders prepared in Examples and Comparative Examples at 100° C. for 1 hour was analyzed, and the results (BET) are shown in Table 2 below.

The particle size distribution by laser diffraction method was measured using a particle size distribution measuring device (S3500, Microtrac) after adding 50 mg of silver powder to 30 ml of ethanol, dispersing the mixed solution in an ultrasonic cleaner for 3 minutes, and the results (D10, D50, D90) are shown in Table 2 below.

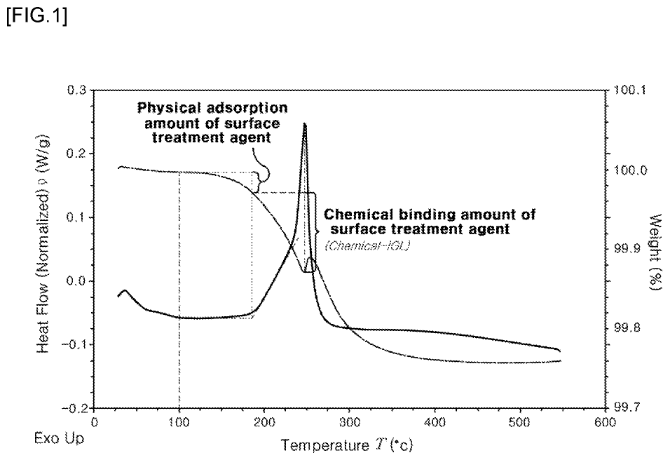

TG/DTA analysis was performed from room temperature to 500° C. in the air at a temperature increase rate of 10° C./min using SDT650 of TA instrument company to measure the organic material content. As shown in FIG. 1, the weight loss from 100° C. to the temperature at which the DTA graph starts to generate heat was considered as the physical adsorption amount of the surface treatment agent, and the weight loss from the temperature at which the DTA graph starts to generate heat was measured as the chemical binding amount by Chemical-IGL, and the results (C-IGL) are shown in Table 2 below.

TABLE 2

| | D10 | D50 | D90 | Chemical-IGL | BET | C-IGL/ |
|---|---|---|---|---|---|---|
| Division | (μm) | (μm) | (μm) | (%) | (m²/g) | BET |
| Example 1 | 1.00 | 2.22 | 3.76 | 0.078 | 0.55 | 0.142 |
| Example 2 | 1.12 | 2.35 | 4.09 | 0.072 | 0.48 | 0.150 |
| Example 3 | 1.13 | 2.37 | 4.14 | 0.081 | 0.46 | 0.176 |
| Example 4 | 1.12 | 2.31 | 4.01 | 0.089 | 0.47 | 0.189 |
| Example 5 | 1.13 | 2.33 | 4.04 | 0.097 | 0.46 | 0.211 |
| Comparative | 1.09 | 2.28 | 4.48 | 0.179 | 0.49 | 0.365 |
| Example 1 | | | | | | |

As shown in Table 2 above, in the case of the coating after adjusting the pH to 8 or more, the particle size distribution and specific surface area are similar, but the chemical binding amount of the coating agent (C-IGL) compared to the case of coating without adjusting the pH decreased.

It can be confirmed that the chemical bonding amount (C-IGL/BET) of the coating agent with respect to the specific surface area of the silver powder is 0.3 or less in the case of Examples.

### Preparation Example—Preparation of the Conductive Paste

10 g of a binder mixed with 7.7% by weight of ETHOCELTM Std200 ethylcellulose (The Dow Chemical Company) and 92.3% by weight of diethyleneglycol monoethylether acetate (Daejung Chemical) and 90 g of a silver powder prepared according to Examples and Comparative Examples were mixed with a rotational vacuum stirring degassing device, then the mixture was milled using three roll milling machine to prepare a conductive paste.

### Experimental Example (2)—Analysis of Viscosity Change Over Time

The viscosity of the obtained conductive paste was measured at 25° C. and 30 RPM using a Brookfield viscometer, DV2T (Digital viscometer). In this case, a small sample adapter and a No. 14 spindle were used.

In order to analyze the viscosity change over time, the viscosity was measured immediately after the conductive paste was prepared, and the viscosity after storage for 24 hours and 48 hours in an oven at 50° C. was measured, respectively.

TABLE 3

| | | | | Increase/ |
|---|---|---|---|---|
| | Time | | Viscosity | decrease |
| | lapse | | (kcps) | rate (%) |
| Example 1 | 0 | hr | 154 | |
| | 24 | hr | 137 | −11% |
| | 48 | hr | 131 | −15% |
| Example 2 | 0 | hr | 156 | |
| | 24 | hr | 137 | −12% |
| | 48 | hr | 129 | −17% |
| Example 3 | 0 | hr | 165 | |
| | 24 | hr | 152 | −8% |
| | 48 | hr | 147 | −11% |
| Example 4 | 0 | hr | 172 | |
| | 24 | hr | 163 | −5% |
| | 48 | hr | 160 | −7% |
| Example 5 | 0 | hr | 186 | |
| | 24 | hr | 182 | −2% |
| | 48 | hr | 180 | −3% |
| Comparative | 0 | hr | 204 | |
| Example 1 | 24 | hr | 173 | −15% |
| | 48 | hr | 161 | −21% |

As shown in the above results, it can be confirmed that the viscosity increase/decrease rate of the conductive pastes according to Examples 1 to 5 was ±12% or less after 24 hours, and the viscosity increase/decrease rate was ±17% or less after 48 hours. In particular, the conductive paste, according to Example 5, in which the pH was adjusted to 11 or higher using ammonium hydroxide as a pH adjusting agent, had a viscosity increase/decrease rate of ±2% after 24 hours and a viscosity increase/decrease rate of ±3% after 48 hours, showing the best viscosity stability.

In Comparative Example 1, it may be seen that it is difficult to ensure viscosity stability because the viscosity increase rate after 24 hours of the conductive paste is ±15%, and the viscosity increase rate after 48 hours is ±21%.

Features, structures, effects, etc. exemplified in each of the above-described embodiments may be combined or modified for other embodiments by those of ordinary skilled in the art to which the embodiments belong. Accordingly, the contents related to such combinations and modifications should be interpreted as being included in the scope of the present disclosure.

1. A method of preparing a silver powder, the method comprising:
preparing silver powder by precipitating silver particles by reducing silver ions after preparing a silver salt containing silver ions;
recovering silver powder by separating silver particles from the aqueous solution or slurry comprising the precipitated silver particles, washing, and drying; and
coating silver powder by coating a pH-adjusted coating agent that a pH control agent is added to the recovered silver powder to adjust the pH, and then a coating agent is adjusted the pH.

2. The method of claim 1, wherein the silver powder coating comprises:
adjusting a pH of a silver powder solution by adding the recovered silver powder to pure water and stirring, then adding a pH adjusting agent and stirring; and
coating the pH-adjusted silver powder solution by adding a coating agent.

3. The method of claim 2, wherein the pH adjusting is adjusting the pH in a range of 8 to 12 by adding 200 to 400 parts by weight of pure water based on 100 parts by weight of the recovered silver powder and stirring for 5 to 15 minutes, then adding the pH adjusting agent and stirring for 5 to 15 minutes.

4. The method of claim 2, wherein in the pH adjusting, the pH adjusting agent comprises at least one selected from the group consisting of 2-amino-2-methyl-1-propanol, triethanolamine, and ammonium hydroxide.

5. The method of claim 1, wherein the coating agent comprises a fatty acid or a salt thereof, wherein the fatty acid comprises at least one selected from the group consisting of stearic acid, oleic acid, myristic acid, palmitic acid, linolic acid, lauric acid, and linoleic acid.

6. A silver powder prepared according to the method of claim 1, wherein the silver powder has a parameter value expressed as a chemical binding amount (%) of a coating agent with respect to a specific surface area (m²/g) of 0.3 or less.

7. A conductive paste comprising:
a metal powder comprising a silver powder prepared according to the method of claim 1; and
a glass vehicle comprising a solvent and an organic binder.

8. A conductive paste for forming a solar cell electrode, the conductive paste comprising:
a metal powder comprising silver powder prepared according to the method of claim 1;
glass frit; and
an organic vehicle comprising a solvent and an organic binder.
